(19) United States
(12) Patent Application Publication
(10) Pub. No.: US 2017/0036769 A1
(43) Pub. Date: Feb. 9, 2017

(54) AIRCRAFT INSULATION SYSTEM AND AIRCRAFT AIR CONDITIONING AND INSULATION ARRANGEMENT

(71) Applicant: Airbus Operations GmbH, Hamburg (DE)

(72) Inventor: Dirk Humfeldt, Hamburg (DE)

(21) Appl. No.: 15/219,546

(22) Filed: Jul. 26, 2016

(30) Foreign Application Priority Data
Aug. 4, 2015 (EP) 15179673.7

(51) Int. Cl. B64D 13/06; B64C 1/06; B64C 1/40

(52) U.S. Cl. CPC B64D 13/06; B64C 1/403; B64C 1/067; B64D 2013/0625; B64D 2013/0688

(57) ABSTRACT

An aircraft insulation system comprising a foil extending at a distance from an inner surface of an aircraft outer shell. An air gap is defined between the foil and the aircraft outer shell. A cabin exhaust air duct is arranged adjacent to an inner surface of the foil and being adapted to have cabin exhaust air flow through the duct.

### CROSS-REFERENCES TO RELATED APPLICATIONS

This application claims the benefit of the European patent application No. 15 179 673.7 filed on Aug. 4, 2015, the entire disclosures of which are incorporated herein by way of reference.

### BACKGROUND OF THE INVENTION

The invention relates to an aircraft insulation system. Furthermore, the invention relates to an aircraft air conditioning and insulation arrangement. Finally, the invention relates to a method of operating an aircraft air conditioning and insulation arrangement.

The primary insulation of an aircraft typically comprises mat-like insulation packages that consist of a puffy mineral fiber material and welded cover films. The insulation packages are installed in an overlapping fashion at a suitable distance from an inner surface of the aircraft outer skin so as to from an air gap between the aircraft outer skin and the insulation packages. An inwardly directed cover film of the insulation packages which faces an aircraft cabin is usually permeable to air in order to allow a pressure compensation between air enclosed in the insulation packages and the surroundings and to simultaneously prevent the insulation packages from inflating and shrinking during pressure variations. To the contrary, an outwardly directed cover film of the insulation packages which faces the aircraft outer skin typically is realized in a waterproof fashion so as to form a condensate barrier in order to protect the cabin and moisture sensitive aircraft systems from dripping water.

During flight operation of the aircraft, the aircraft outer skin may have a temperature between −30° C. and −55° C. As a result, the location with the dew point temperature of the cabin air typically is located within the insulation packages. Due to pressure variations and diffusion effects, warm and humid cabin air is continuously admitted into the insulation packages through the perforated film facing the cabin. Condensation takes place if this air penetrates into the insulation material up to the location with the dew point temperature. The mineral fibers of the insulation packages absorb drops of the condensate and prevent the drainage thereof. Thus, the insulation packages absorb significant quantities of water, which leads to an increase of their weight and a reduction of their insulation efficiency.

In order to reduce the absorption of water in aircraft primary insulation packages, DE 10 2010 052 671 A1 and US 2013/299630 A1 propose to equip the aircraft primary insulation packages with cover films that are realized in an airtight and waterproof fashion and ventilation openings such that an air exchange with the interior of the insulation packages can only take place through the ventilation openings.

At present, air conditioning systems used in aircraft for ventilating and pressurizing the aircraft cabin work on the principle of mixing ventilation, wherein air, which is temperature-controlled as required, is blown into the aircraft cabin with a high impulse and at a high speed through air inlets usually arranged in the ceiling region of a part of the aircraft to be ventilated. Owing to the high impulse and the high speed of the air blown in, tumble air movements form in the aircraft cabin which ensure a virtually homogeneous intermixing of the air with the ambient air. Free convection induced by heat sources and cold or hot surfaces is dominated by the forced flow of the tumble air movements.

An alternative aircraft air conditioning system which works on the principle of displacement ventilation is described in EP 2 203 348 B1 and US 2010/240290 A1. In this system, air is supplied into an aircraft cabin to be air conditioned via an air inlet located near the floor of the aircraft cabin at a low speed and distributed over the floor area so as to form a conditioned air layer over the entire floor area. The conditioned air then rises at heat sources present in the aircraft cabin due to natural convection and exits the aircraft cabin via an air inlet arranged in a ceiling region of the aircraft cabin. From the air inlet, cabin exhaust air is directed through an exhaust air duct extending along the ceiling region of the aircraft cabin and further into a connecting duct extending along an aircraft outer skin and following, for example, the course of a frame. The connecting duct directs the air discharged from the aircraft cabin to a pressure regulating valve which is located in the region of an aircraft lower shell.

### SUMMARY OF THE INVENTION

The invention is directed at an object of providing a lightweight, but still effective aircraft insulation system. Furthermore, the invention is directed at an object of providing an arrangement comprising such an aircraft insulation system and an aircraft air conditioning system. Finally, the invention is directed at an object of providing a method of operating an arrangement comprising such an aircraft insulation system and an aircraft air conditioning system.

An aircraft insulation system comprises a foil extending at a distance from an inner surface of an aircraft outer shell. An air gap is defined between the foil and the aircraft outer shell. The air gap is filled with air that is entrapped between the foil and the aircraft outer shell. The air entrapped between the foil and the aircraft outer shell already provides for a thermal insulation of an interior of an aircraft cabin against the aircraft outer shell which during flight operation of the aircraft may be cooled to a temperature of approximately −30° C. to −55° C. Preferably, the foil extends substantially parallel to the aircraft outer shell, at least in the region of an upper shell of the aircraft.

A cabin exhaust air duct is arranged adjacent to an inner surface of the foil and is adapted have cabin exhaust air flow through the duct. Basically, the cabin exhaust air duct may be defined by a line or pipe. Preferably, however, the cabin exhaust air duct, at least in the region of an upper deck of the aircraft, is defined by a free space existing adjacent to the inner surface of the foil. Warm and humid cabin exhaust air that is discharged from the aircraft cabin via the cabin exhaust air duct thus further insulates the interior of the aircraft cabin against the cold aircraft outer shell. The foil separates the air entrapped between the foil and the aircraft outer shell from the warm and humid cabin exhaust air flowing through the cabin exhaust air duct. As a result, thermal energy losses can be reduced. Further, icing of the inner surface of the aircraft outer shell due to the humidity contained in the cabin exhaust air is prevented.

Since in the aircraft insulation system the thermal insulation function is provided by the layer of entrapped air which is formed between the foil and the aircraft outer shell and the layer of cabin exhaust air flowing through the cabin exhaust air duct, conventional primary insulation packages can be dispensed with. As a result, the aircraft insulation system is distinguished by a particularly low weight per se. In addition, an accumulation of moisture and hence a weight gain as it occurs in prior art insulation systems comprising mineral fiber containing insulation packages, can be avoided. The aircraft insulation system thus is particularly advantageous for use in aircraft that are operated in humid conditions which make drying of the insulation packages during ground operation of the aircraft difficult.

Basically, the aircraft insulation system can be employed in any aircraft and in combination with any aircraft air conditioning system. However, a particularly effective insulation of an aircraft passenger cabin, which typically is arranged in an upper shell region of the aircraft, can be achieved, if the cabin exhaust air duct comprises a cabin exhaust air inlet arranged in the ceiling region of the aircraft cabin, since the warm and humid cabin exhaust air then may be directed from a ceiling region of the aircraft upper shell along sidewalls of the aircraft cabin. As a result, the aircraft cabin, along its sidewalls, is effectively insulated from the cold aircraft outer shell.

In an aircraft air conditioning system which works on the principle of displacement ventilation as described in EP 2 203 348 B1 and US 2010/240290 A1, conditioned air is supplied to the aircraft cabin close to the floor of the aircraft cabin and then rises at heat sources present in the aircraft cabin due to natural convection. Cabin exhaust air is discharged from a ceiling region of the aircraft cabin. The aircraft insulation system thus is particularly suitable for use in combination with an aircraft air conditioning system which works on the principle of displacement ventilation as described in EP 2 203 348 B1 and US 2010/240290 A1.

In a preferred embodiment of the aircraft insulation system, the cabin exhaust air duct extends from the ceiling region of the aircraft cabin substantially parallel to the aircraft outer shell into a lower deck of the aircraft. The cabin exhaust air duct then ensures a continuous, effective insulation of the entire aircraft cabin from the cold aircraft outer shell.

At least a part of the cabin exhaust air flowing through the cabin exhaust air duct may be directed into a freight compartment of the aircraft, which typically is arranged in a lower deck region of the aircraft. Furthermore, at least a part of the cabin exhaust air flowing through the cabin exhaust air duct may be directed into a mixer of an aircraft air conditioning system. Within the mixer, the cabin exhaust air may be mixed with cold conditioned air provided by an air conditioning unit of the air conditioning system before being recirculated into the aircraft cabin. Finally, at least a part of the cabin exhaust air flowing through the cabin exhaust air duct may be discharged over board of the aircraft via a pressure regulation valve in order to regulate an aircraft cabin pressure. Water which condenses from the cabin exhaust air stream upon flowing through the cabin exhaust air duct may also be discharged over board of the aircraft via the pressure regulation valve. It is, however, also conceivable to provide a water separator in the cabin exhaust air duct in order to separate condensate from the cabin exhaust air stream.

Upon flowing through the cabin exhaust air duct during flight operation of the aircraft, the cabin exhaust air is cooled due to the transfer of thermal energy from the cabin exhaust air to the cold aircraft outer shell. As a result, the cabin exhaust air can be supplied to a mixer of an air conditioning system as recirculation air already in a precooled state. Consequently, energy consumption of an air conditioning unit of the air conditioning system for providing cold conditioned air can be significantly reduced.

The aircraft insulation system preferably comprises a control unit which is adapted to control a flow of cabin exhaust air through the cabin exhaust air duct in such a manner that the cabin exhaust air, upon flowing through the cabin exhaust air duct, is cooled to a temperature of approximately 5° C. to 10° C. For example, the control unit may control a conveying device for conveying the cabin exhaust air through the cabin exhaust air duct in such a manner that the volume flow of cabin exhaust air through the cabin exhaust air duct is suitably adjusted in dependence on the temperature of the aircraft outer shell in order to ensure cooling of the cabin exhaust air upon flowing through the cabin exhaust air duct to the desired temperature of approximately 5° C. to 10° C. When the cabin exhaust air, upon flowing through the cabin exhaust air duct, is cooled to a temperature of approximately 5° C. to 10° C., the formation of ice due to the condensation of moisture contained in the cabin exhaust air, for example at the inner surface of the foil, can be avoided.

Preferably, the foil is made of a watertight and/or airtight material. A watertight foil prevents condensate formed in the cabin exhaust air duct from entering the air gap defined between the foil and the aircraft outer shell. Hence, icing of the inner surface of the aircraft outer shell can be avoided. An airtight foil prevents an air exchange between the cabin exhaust air duct and the air gap defined between the foil and the aircraft outer shell and hence also prevents moisture contained in the cabin exhaust air flowing through the cabin exhaust air duct from entering the air gap defined between the foil and the aircraft outer shell. For example, the foil may be made of a watertight and airtight plastic material.

Although the use of an airtight foil may be advantageous for preventing moisture from entering the air gap defined between the foil and the aircraft outer shell, the foil should still not form an airtight seal between the cabin exhaust air duct and the aircraft outer shell. Instead, the “barrier” defined by the foil should be permeable to air to such an extent that pressure equalization between the cabin exhaust air duct and the air gap defined between the foil and the aircraft outer shell is possible. This is usually achieved by fastening the foil in a non-sealing manner such that a certain air exchange between the cabin exhaust air duct and the air gap defined between the foil and the aircraft outer shell inevitably occurs even in case the foil itself is made of an airtight material.

Preferably, the foil comprises a plurality of foil sheets. The foil sheets may extend in a circumferential direction of the aircraft outer shell. Preferably, the foil sheets are attached to an aircraft primary structure. For example, the foil sheets may be attached to stringers and/or frames of the aircraft primary structure. In a preferred embodiment, the foil sheets extend in a circumferential direction of the aircraft outer shell between pairs of adjacent frames of the aircraft primary structure.

The foil sheets may be attached to components, in particular the frames of the aircraft primary structure by means of a clamping arrangement. The clamping arrangement may be configured to apply a clamping force in order to clamp the foil sheets to the components, in particular the frames of the aircraft primary structure.

For example, the clamping arrangement may comprise a first and a second clamping element. The first and the second clamping element may be made of a plastic material. Further, the first and the second clamping element may be connected by means of a pin extending through a frame of the aircraft primary structure so as to fasten a first and a second foil sheet to opposing side surfaces of the frame. In particular, each of the first and the second clamping element may have an L-shape cross-section with a first leg and a second leg. The first leg, which may abut against the inner surface of the foil, may press the foil against a surface of a stringer which faces the aircraft cabin. The second leg, which may also abut against the inner surface of the foil, may press the foil against a side surface of the frame.

The clamping arrangement may further comprise a clip extending from the inner surface of the aircraft outer shell adjacent to a side surface of the frame so as to be arranged between the first or the second clamping element and the side surface of the frame. The provision of a clamping arrangement as described above simplifies the installation of the foil sheets in the aircraft.

Preferably, a spacing between adjacent clamping arrangements in a circumferential direction of the aircraft outer shell is twice of the spacing between adjacent stringers of the aircraft primary structure. Deformation and in particular sagging of the foil can thus be prevented.

An aircraft air conditioning and insulation arrangement comprises an air conditioning unit for generating conditioned air and an above-described aircraft insulation system. The air conditioning unit and the cabin exhaust air duct are connected to a mixer adapted to mix the conditioned air generated by the air conditioning unit with at least a part of the cabin exhaust air discharged from the aircraft cabin via the cabin exhaust air duct. As already indicated above, by supplying the mixer with cabin exhaust air which is already precooled due to the transfer of thermal energy to the cold aircraft outer shell upon flowing through the cabin exhaust air duct, the energy consumption of the air conditioning unit can be significantly reduced.

In the aircraft air conditioning and insulation arrangement, the cabin exhaust air duct may be connected to a pressure regulation valve which is adapted to allow the discharge of at least a part of the cabin exhaust air flowing through the cabin exhaust air duct over board of the aircraft in order to regulate an aircraft cabin pressure. For example, the cabin exhaust air duct may comprise two branch ducts, one being connected to the mixer and one being connected to the pressure regulation valve.

In a method of operating an aircraft air conditioning and insulation arrangement, conditioned air is generated by means of an air conditioning unit. Cabin exhaust air is discharged from an aircraft cabin via a cabin exhaust air duct, the cabin exhaust air duct being arranged adjacent to an inner surface of a foil extending at a distance from an inner surface of an aircraft outer shell so as to define an air gap between the foil and the aircraft outer shell. The conditioned air generated by the air conditioning unit is mixed with at least a part of the cabin exhaust air discharged from the aircraft cabin via the cabin exhaust air duct

Preferably, the cabin exhaust air is discharged from a ceiling region of the aircraft cabin via a cabin exhaust air inlet of the cabin exhaust air duct.

The cabin exhaust air may be directed through the cabin exhaust air duct from the ceiling region of the aircraft cabin substantially parallel to the aircraft outer shell into a lower deck of the aircraft.

At least a part of the cabin exhaust air flowing through the cabin exhaust air duct may be discharged over board of the aircraft via a pressure regulation valve connected to the cabin exhaust air duct in order to regulate an aircraft cabin pressure.

### BRIEF DESCRIPTION OF THE DRAWINGS

Preferred embodiments of the invention now are described in greater detail with reference to the appended schematic drawings, wherein

FIG. 1 shows an aircraft air conditioning and insulation arrangement, and

FIG. 2 shows a detailed view of an aircraft insulation system employed in the aircraft air conditioning and insulation arrangement of FIG. 1.

### DETAILED DESCRIPTION OF THE PREFERRED EMBODIMENTS

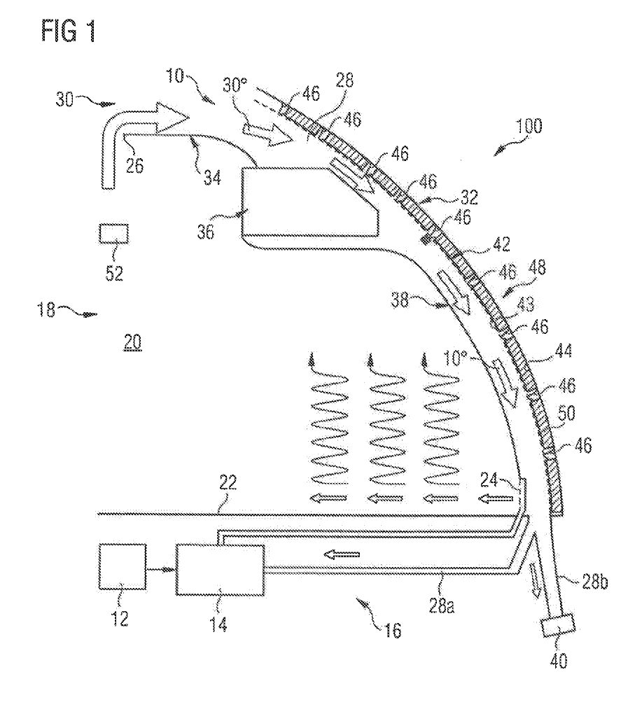

An aircraft air conditioning and insulation arrangement 100 according to FIG. 1 comprises an aircraft insulation system 10 and an air conditioning unit 12. The air conditioning unit 12 is operable so as to provide cool conditioned air to a mixer 14. As becomes apparent from FIG. 1, the air conditioning unit 12 and the mixer 14 are arranged in the region of a lower deck 16 of the aircraft. The lower deck 16 is separated from an upper deck 18, which accommodates an aircraft cabin 20, for example, a passenger cabin, by a floor 22.

The aircraft cabin 20 is air-conditioned by supplying air from the mixer 14 into the aircraft cabin 20 via conditioned air inlets 24 which are formed in sidewalls of the aircraft cabin 20 close to the floor 22. The conditioned air exits the conditioned air inlets 24 at a low speed of approximately 0.1 to 0.5 m/s so as to form a conditioned air layer over the floor area. The conditioned air then rises at heat sources present in the aircraft cabin 20, for example passengers, due to natural convection at a speed of approximately 0.05 m/s and exits the aircraft cabin 20 via a cabin exhaust air outlet 26 of a cabin exhaust air duct 28. The cabin exhaust air outlet 26 is arranged in the region of a ceiling 30 of the aircraft cabin 20. The cabin exhaust air duct 28 extends from the ceiling region of the aircraft cabin 20 in a circumferential direction of an aircraft outer shell 32 into the lower deck 16. In particular, the cabin exhaust air duct 28 extends substantially parallel to the aircraft outer shell 32 between the aircraft outer shell 32 and back walls of interior components such as ceiling panels 34, overhead luggage compartments 36 and sidewall panels 38. Basically, the cabin exhaust air duct 28 may be defined by a line or pipe. Preferably, however, the cabin exhaust air duct 28, in the region of the upper deck 18, is defined by a free space existing between the aircraft outer shell 32 and the back walls of the interior components.

In the region of the lower deck 16, the cabin exhaust air duct 28 comprises a first branch 28a and a second branch 28b. The first branch 28a of the cabin exhaust air duct 28 opens into the mixer 14 so as to supply cabin exhaust air discharged from the aircraft cabin 20 via the cabin exhaust air duct 28 to the mixer 14 as recirculation air. Within the mixer 14, the cabin exhaust air is mixed with the conditioned air generated by the air conditioning unit 12 and finally recirculated into the aircraft cabin 20 via the conditioned air inlets 24. The second branch 28b of the cabin exhaust air duct 28 is connected to a pressure regulation valve 40. Via the pressure regulation valve 40, cabin exhaust air flowing through the cabin exhaust air duct 28 may be discharged over board of the aircraft if needed for regulating an aircraft cabin pressure.

The cabin exhaust air duct 28, which forms a part of the aircraft insulation system 10, at a side facing the aircraft outer shell 32, is delimited by a foil 42. The cabin exhaust air duct 28 thus is arranged adjacent to an inner surface 43 of the foil 42. The foil 42, which is made of an airtight and watertight material, in particular an airtight and watertight plastic material, extends at a distance from an inner surface 44 of the aircraft outer shell 32. In particular, the foil 42 extends substantially parallel to the aircraft outer shell 32, wherein the distance between the inner surface 44 of the aircraft outer shell 32 and the foil 42 substantially corresponds to the extension of stringers 46, which form components of the aircraft primary structure 48, from the inner surface 44 of the aircraft outer shell 32 in a radial direction.

An air gap 50 is defined between the foil 42 and the aircraft outer shell 32. The air gap 50 is filled with air that is entrapped between the foil 42 and the aircraft outer shell 32. The air entrapped between the foil 42 and the aircraft outer shell 32 already provides for a thermal insulation of an interior of the aircraft cabin 20 against the aircraft outer shell 32 which during flight operation of the aircraft may be cooled to a temperature of approximately −30° C. to −55° C. A further insulation layer, which effectively insulates the aircraft cabin 20 against the cold aircraft outer shell 32, is formed by the warm and humid cabin exhaust air that is discharged from the aircraft cabin via the cabin exhaust air duct 28.

As a result, in the aircraft insulation system 10, conventional primary insulation packages can be dispensed with. Due to the presence of the foil 42, the air entrapped between the foil 42 and the aircraft outer shell 32 is separated from the warm and humid cabin exhaust air flowing through the cabin exhaust air duct 28 and hence, thermal energy losses can be reduced. Furthermore, icing of the inner surface 44 of the aircraft outer shell 32 due to the humidity contained in the cabin exhaust air is prevented.

As indicated in FIG. 1, upon flowing through the cabin exhaust air duct 28, the cabin exhaust air, due to the transfer of thermal energy to the cold aircraft outer shell 32, is cooled from a temperature of approximately 30° C. in the region of the cabin exhaust air outlet 26 to approximately 10° C. in the region of the floor 22. Specifically, a flow of cabin exhaust air through the cabin exhaust air duct, by means of a control unit 52, is controlled in such a manner that the cabin exhaust air, upon flowing through the cabin exhaust air duct, is cooled to a temperature of approximately 5° C. to 10° C. For example, the control unit 52 may control a conveying device (not shown) for conveying the cabin exhaust air through the cabin exhaust air duct 28 in such a manner that the volume flow of cabin exhaust air through the cabin exhaust air duct 28 is suitably adjusted in dependence on the temperature of the aircraft outer shell 32 in order to ensure cooling of the cabin exhaust air upon flowing through the cabin exhaust air duct 28 to the desired temperature of approximately 5° C. to 10° C.

Due to being precooled upon flowing through the cabin exhaust air duct 28, the cabin exhaust air enters the mixer 14 at a temperature that is significantly lower than the temperature at the cabin exhaust air in the region of the cabin exhaust air outlet 28. As a result, energy consumption of the air conditioning unit 12 for providing cold conditioned air to be mixed with the cabin exhaust air can be reduced. In addition, when the cabin exhaust air, upon flowing through the cabin exhaust air duct, by means of the control unit 52, is cooled to a temperature of approximately 5° C. to 10° C., the formation of ice due to the condensation of moisture contained in the cabin exhaust air, for example at the inner surface of the foil 42, can be avoided.

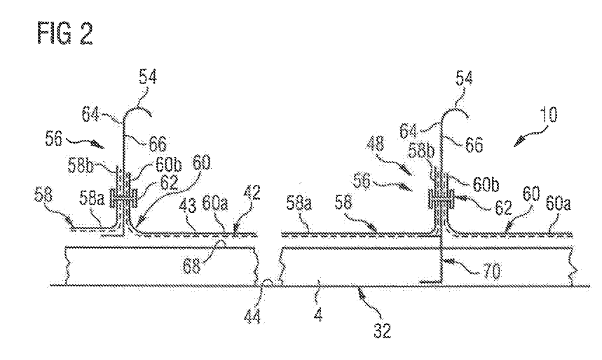

As becomes apparent from FIG. 2, the foil 42 comprises a plurality of foil sheets 42a, 42b, 42c that are attached to the aircraft primary structure 48. In particular, the individual foil sheets 42a, 42b, 42c extend in a circumferential direction along of the aircraft outer shell 32 between pairs of adjacent frames 54 of the aircraft primary structure 48. The foil sheets 42a, 42b, 42c are attached to the frames 54 by means of clamping arrangements 56.

Each clamping arrangement 56 comprises a first and a second clamping element 58, 60 which are connected to each other by means of a pin 62 extending through one of the frames 54, while clamping edges of two adjacent foil sheets 42a, 42b, 42c therebetween against opposing side surfaces 64, 66 of the frame 54. The foil sheets 42a, 42b, 42c thus are fastened to the opposing side surfaces 64, 66 of the frame 54. Each of the first and the second clamping element 58, 60 is made of a plastic material and has an L-shape cross-section with a first leg 58a, 60a and a second leg 58b, 60b. The first leg 58a, 60a, which abuts against the inner surface 43 of the foil 42, presses the foil 42 against a surface 68 of a stringer 46 which faces the aircraft cabin 20. The second leg 58b, 60b, which also abuts against the inner surface 43 of the foil 42, presses the foil 42 against a side surface 64, 66 of the frame 54. The clamping arrangement 56 further comprises a clip 70 extending from the inner surface 44 of the aircraft outer shell 32 adjacent to a side surface 64 of the frame 54 so as to be arranged between the first clamping element 58 and the side surface 64 of the frame 54.

A spacing between adjacent clamping arrangements 56 in a circumferential direction of the aircraft outer shell 32 is twice of the spacing between adjacent stringers 46 of the aircraft primary structure 48. Deformation and in particular sagging of the foil 42 can thus be prevented.

If the foil 42 is attached in a non-sealing manner, for example as described above, a certain air exchange between the cabin exhaust air duct 28 and the air gap 50 defined between the foil 42 and the aircraft outer shell 32 inevitably occurs even in case the foil 42 itself is made of an airtight material. Hence, the “barrier” defined by the foil 42 is permeable to air to such an extent that a desired pressure equalization between the cabin exhaust air duct 28 and the air gap 50 defined between the foil 42 and the aircraft outer shell 32 is possible.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft insulation system comprising:
a foil extending at a distance from an inner surface of an aircraft outer shell,
an air gap defined between the foil and the aircraft outer shell, and
a cabin exhaust air duct arranged adjacent to an inner surface of the foil and being adapted to allow cabin exhaust air to flow through the duct.

2. The aircraft insulation system according to claim 1, wherein the cabin exhaust air duct comprises a cabin exhaust air outlet arranged in a ceiling region of an aircraft cabin.

3. The aircraft insulation system according to claim 1, wherein the cabin exhaust air duct extends from the ceiling region of the aircraft cabin substantially parallel to the aircraft outer shell into a lower deck of the aircraft.

4. The aircraft insulation system according to claim 1, further comprising a control unit adapted to control a flow of cabin exhaust air through the cabin exhaust air duct in such a manner that the cabin exhaust air, upon flowing through the cabin exhaust air duct, is cooled to a temperature of approximately 5° C. to 10° C.

5. The aircraft insulation system according to claim 1, wherein the foil is made of a watertight material.

6. The aircraft insulation system according to claim 1, wherein the foil is made of an airtight material.

7. The aircraft insulation system according to claim 1, wherein the foil comprises a plurality of foil sheets attached to an aircraft primary structure, the foil sheets extending between pairs of adjacent frames of the aircraft primary structure.

8. The aircraft insulation system according to claim 7, wherein the foil sheets are attached to the frames of the aircraft primary structure by means of a clamping arrangement.

9. The aircraft insulation system according to claim 8, wherein the clamping arrangement comprises a first and a second clamping element which are connected by means of a pin extending through a frame of the aircraft primary structure so as to fasten a first and a second foil sheet to opposing side surfaces of the frame.

10. The aircraft insulation system according to claim 8, wherein the clamping arrangement further comprises a clip extending from the inner surface of the aircraft outer shell adjacent to a side surface of the frame so as to be arranged between the first or the second clamping element and the side surface of the frame.

11. The aircraft insulation system according to claim 8, wherein a spacing between adjacent clamping arrangements in a circumferential direction of the aircraft outer shell is twice of the spacing between adjacent stringers of the aircraft primary structure.

12. An aircraft air conditioning and insulation arrangement comprising:
an air conditioning unit for generating conditioned air, and
an aircraft insulation system according to claim 1,
wherein the air conditioning unit and the cabin exhaust air duct are connected to a mixer adapted to mix the conditioned air generated by the air conditioning unit with at least a part of the cabin exhaust air discharged from an aircraft cabin via the cabin exhaust air duct.

13. The aircraft air conditioning and insulation arrangement according to claim 12, wherein the cabin exhaust air duct is connected to a pressure regulation valve adapted to allow the discharge of at least a part of the cabin exhaust air flowing through the cabin exhaust air duct over board of the aircraft in order to regulate an aircraft cabin pressure.

14. A method of operating an aircraft air conditioning and insulation arrangement comprising:
generating conditioned air by means of an air conditioning unit,
discharging cabin exhaust air from an aircraft cabin via a cabin exhaust air duct, the cabin exhaust air duct being arranged adjacent to an inner surface of a foil extending at a distance from an inner surface of an aircraft outer shell so as to define an air gap between the foil and the aircraft outer shell, and
mixing the conditioned air generated by the air conditioning unit with at least a part of the cabin exhaust air discharged from the aircraft cabin via the cabin exhaust air duct.

15. The method according to claim 14, wherein the cabin exhaust air is discharged from a ceiling region the aircraft cabin via a cabin exhaust air outlet of the cabin exhaust air duct.

16. The method according to claim 14, wherein the cabin exhaust air is directed through the cabin exhaust air duct from the ceiling region of the aircraft cabin substantially parallel to the aircraft outer shell into a lower deck of the aircraft.

17. The method according to claim 14, wherein at least a part of the cabin exhaust air flowing through the cabin exhaust air duct is discharged over board of the aircraft via a pressure regulation valve connected to the cabin exhaust air duct in order to regulate an aircraft cabin pressure.
